(19) United States
(12) Patent Application Publication
(10) Pub. No.: US 2006/0100939 A1
(43) Pub. Date: May 11, 2006

(54) Method and system for managing commodity information in a supply chain of production

(76) Inventors: Rejean Boyer, Brampton (CA); Rod Perry, Georgetown (CA); Ward Metzler, Burlington (CA)

Correspondence Address: Linda D Birch;E I Du Pont De Nemours and Company, Legal Patent Records Center, 4417 Lancaster Pike, Wilmington, DE, 19805, US

(21) Appl. No.: 10/517,561

(22) PCT Filed: Jun. 5, 2003
(86) PCT No.: PCT/CA03/00853

§ 371 Date: Sep. 8, 2005

(30) Foreign Application Priority Data
Jun. 7, 2002 (CA) 2 390 056

(51) Int. Cl. A01K 5/02; G06F 17/50

(52) U.S. Cl. 705/28; 705/29

(57) ABSTRACT

The invention pertains to a method and system for managing commodity information as a commodity flows through a supply chain of production.

### TECHNICAL FIELD

The invention pertains to a method and system for managing commodity information as a commodity flows through a supply chain of production.

### BACKGROUND OF THE INVENTION

Many supply chains of production deal with commodities such as raw or partially processed materials or other articles which are bought and sold. In such chains of production, the commodity is sourced from at least one entity, processed in one or more steps and, typically, transferred between one or more entities in the supply chain. A discrete quantity of a commodity (e.g. a lot) may be acquired, blended with other lots, refined, transported, or combined with one or more other lots of other commodities. Increasingly, to meet a variety of producer and consumer interests, there is a need to determine and track commodity characteristics through the supply chain, particularly as a commodity moves between entities in such a chain.

By way of example, agricultural commodities derived from cultivating the soil or rearing animals and including crops such as grain, fruit and vegetables as well as other commodities derived therefrom, such as meat, flour, and prepared foods for humans or animals, etc., are classified according to certain characteristics. Often, there is a need to determine one or more inherent characteristics of a particular commodity in order to further determine a quality characteristic or other standard measure for the commodity. Rudimentary methods for determining commodity characteristics include the visual inspection of the commodity and, typically, a subjective comparison to a defined standard. However, more sophisticated computerized detection and comparison methods are also known.

By way of example, the Canadian Grain Commission (CGC) regulates the quality of all grains in Canada. One aspect of grain analysis in Canada is the determination of the Kernel Visual Distinctiveness (KVD) of wheat varieties. This measure helps to track varieties that have specific baking characteristics. CGC monitors customers' needs and adjusts the CGC grading structure according to market demands. CGC also offers an inspection service that is used by grain elevator operators and the Canadian Wheat Board (CWB). A CGC grain inspector evaluates samples of a grain shipment visually to determine grain characteristics and compares the characteristics to the CGC standard. Elevator operators purchase grain from farmers on behalf of the CWB. The elevator operators may blend grain from several farmers in order to produce an amount of grain that meets a predefined quality grade level. The price for such grain paid to the farmer by the elevator operator and to the elevator operator by the CWB is determined, in part, by the grade of the grain.

Grain shipments are analyzed numerous times between field and market. For example, grain is analyzed at the farmer's local elevator before it is loaded for transporting and is evaluated again when received on behalf of the CGC. Grain elevator operators risk that the grade evaluation may not be the same at the receiving end as it was at its origin. When a grain shipment is evaluated to a lower grade, the elevator operator receives less money than expected from the CWB; however, compensation cannot be sought from the farmer.

Although the CGC's grading system is very precise, it is difficult to implement. This can be attributed to sampling bias and the subjectivity of the visual inspection by different inspectors on different days.

Computerized analysis systems to determine one or more characteristics of a commodity are well known. For example, U.S. Pat. No. 6,324,531 issued Nov. 27, 2001 of Anderson et al. discloses a system for identifying the geographic origin of a fresh commodity. The system analyzes samples of the commodity for elemental concentrations. It also employs a neural network model and a bootstrap aggregating strategy to determine a classification of each sample indicative of the sample's origin. U.S. Pat. No. 5,917,927 issued Jun. 29, 1999 of Satake et al. discloses an apparatus and method for the inspection of rice and other grains to determine broken rice content. U.S. Pat. No. 5,321,764 issued Jun. 14, 1994 discloses the identification of wheat cultivars by computerized visual imaging analysis.

In view of the dispersed nature of the production and distribution of agricultural commodities, and, often, the perishable nature of the commodity, it is generally impractical to conduct analyses using only one instrument. As noted, grain requires analysis at several locations over a wide geographic area in a relatively short time frame. Therefore, commodity analysis systems are usually distributed widely and may be positioned throughout the supply chain in various locations. In some cases, more than one commodity analysis system may exist at a single test location.

While these respective commodity analysis systems facilitate a more objective determination of the one or more characteristics of the respective commodities to which the systems are directed, each system tends to operate autonomously. The systems are not coupled to provide the analysis data resulting from the tests to one another or to a collection system. The analysis data is not conveniently available for correlation or for review by users and others interested in the commodity.

Increasingly, a variety of identity preservation, specialty trait tracking and food safety certification programs are being adopted for a variety of commodities. Such programs impose one or more specifications defining standards for commodity characteristics for products used or produced in a supply chain. For example, a program may require the identification of the variety of a particular discrete quantity of a commodity as comprising a non-genetically modified organism (non-GMO). In addition to defining standards for the commodity itself, some programs mandate standards of production for the commodity. Such standards may relate to growing or raising conditions as well as to other production and processing conditions. Many food safety and other certification programs mandate such standards.

To adhere to the standards, for particular quantities of the commodity used or produced in the supply chain, the required commodity must be analyzed and the characteristics identified. Thereafter, those quantities that meet the standard are segregated from other quantities whose characteristics cannot be assured. Further, as those quantities move through the supply chain, the characteristics are monitored to preserve adherence to the standards.

There is therefore a need for a system and method to manage commodity data in a chain of production.

### SUMMARY OF THE INVENTION

There is provided a system for and method of managing commodity data for a chain of production in which one or more commodities are used in one or more production steps.

In accordance with an aspect of the invention, for an information retrieval system coupled to at least one commodity analysis system configured to analyze at least one commodity to generate commodity data comprising at least one commodity characteristic, there is provided a method of managing the commodity data for a chain of production in which one or more commodities are used in one or more production steps. The method comprises receiving the commodity data from the at least one commodity analysis system for discrete quantities of at least one commodity used or produced by the chain of production; storing the commodity data to the information retrieval system; and determining commodity information in accordance with the contents of the information retrieval system.

The at least one commodity may comprise one of an agricultural commodity, an aquacultural commodity, an industrial commodity, a biological commodity and a pharmaceutical commodity. The production steps may comprise one or more of acquiring, blending, refining, and transporting the discrete quantities where the commodity data is generated in response to a production step.

In accordance with a feature of this method, the commodity information is provided to determine a use of at least a portion of at least one of the discrete quantities in the chain of production. The use may be defined in accordance with a standard responsive to one or more commodity characteristics. The standard may define one of an identity preservation program, a specialty trait tracking program and a food safety certification program.

Determining commodity information may include tracing commodity data for particular discrete quantities as these quantities flow through the chain of production. For example, in such a case, instances of the commodity data are generated for a particular discrete quantity as the quantity flows through the chain of production and tracing comprises associating instances of the commodity data with one another in the information retrieval system.

As a further feature of this method, the at least one commodity characteristic may include at least one of a measured characteristic of the particular discrete quantity and a secondary characteristic determined for the particular discrete quantity. Further the commodity data may include one or more source data identifying characteristics of the source of the commodity.

The method may further feature transmitting an update to at least one of the commodity analysis systems. The update may comprises at least one of a software update, a lease update, and a data update.

As a further feature, the method may include providing a user interface for obtaining commodity information determined from commodity data stored to the information retrieval system.

In accordance with an aspect of the invention, there is provided a method of managing commodity data for a chain of production in which one or more commodities are used in one or more process steps. The method comprises generating commodity data for a plurality of discrete quantities of at least one commodity used or produced by the chain of production, the commodity data comprising at least one commodity characteristic produced by analyzing the particular discrete quantity using a commodity analysis system; and transmitting the commodity data for storing to an information retrieval system configured for receiving commodity data from a plurality of commodity analysis systems.

The at least one commodity may comprise one of an agricultural commodity, an aquacultural commodity, an industrial commodity, a biological commodity and a pharmaceutical commodity. The production steps may comprise one or more of acquiring, blending, refining, and transporting the discrete quantities where the commodity data is generated in response to a production step.

A feature of the present method comprises retrieving commodity information in accordance with the content of the information retrieval system. In response to the commodity information, the method may include determining a use in the chain of production of at least a portion of at least one of the discrete quantities. The use may be defined in accordance with a standard responsive to one or more commodity characteristics. The standard may further define one of an identity preservation program, a specialty trait tracking program and a food safety certification program.

Retrieving commodity information may include tracing commodity data for particular discrete quantities as said quantities flow through said chain of production.

The at least one commodity characteristic may comprise at least one of a measured characteristic of the particular discrete quantity and a secondary characteristic determined for the particular discrete quantity.

As a further feature of the present aspect, generating commodity data may comprise generating measurement data and examining said measurement data in accordance with a library of comparative data for determining commodity characteristics. Further, the commodity analysis systems may be configured to determine the commodity characteristics in accordance with artificial intelligence.

Generating commodity data may include entering commodity data using a user interface of said commodity analysis system and the method may further comprise correlating commodity data entered using the interface with commodity data produced by an analysis.

A further feature of the present method provides that at least one commodity analysis system periodically gathers commodity data from a plurality of commodity analyses into a batch transmits said batch.

The method optionally includes receiving an update transmitted from the information retrieval system to the commodity analysis system. The update could comprise at least one of a software update, a lease update, and a data update.

In accordance with yet a further aspect, for an information retrieval system coupled to a commodity analysis system configured to analyze at least one commodity to generate commodity data for a chain of production in which one or more commodities are used in one or more process steps, there is provided a method of managing the commodity analysis system comprising receiving commodity data at the information retrieval system from the commodity analysis system for discrete quantities of at least one commodity used or produced by the chain of production; and tracking a use of the commodity analysis system.

The present method may include invoicing in response to the determined use of the commodity analysis system. Further, this may comprise transmitting an update to the commodity analysis system. The update could comprise at least one of a software update, a lease update, and a data update.

As a feature of this present aspect, the method may include configuring the commodity analysis system to at least one of: automatically transmit commodity data to the information retrieval system, receive an update from the information retrieval system, and fail to generate commodity data in the absence of a current permission defined by said information retrieval system.

Another aspect of the invention provides a computer system for managing commodity data for a chain of production in which one or more commodities are used in one or more process steps. The system comprises an information retrieval system for storing commodity data for a plurality of discrete quantities of at least one commodity used or produced by the chain of production, the commodity data for each particular discrete quantity comprising at least one commodity characteristic; and a plurality of commodity analysis systems coupled to the data storage system for generating commodity data to be stored by the data storage system, each commodity analysis system operating under control of a program to perform commodity analysis and storage operations as identified by said program; and each commodity analysis system including at least one instrument for analyzing the commodity for determining the at least one commodity characteristic.

Each commodity analysis system may comprise a user interface for receiving commodity data for storing to said information retrieval system in association with commodity data determined by analysis.

Each commodity analysis system may be configured to retrieve commodity information from said information retrieval system.

In accordance with a feature of the system, the commodity information is retrieved for determining a use in the chain of production of at least a portion of at least one of the discrete quantities.

The information retrieval system is preferably configured to enable tracing of commodity data as particular quantities of a commodity flow through said chain of production.

The commodity analysis system may be configured for determining at least one commodity characteristic for evaluating compliance with a commodity standard. The commodity standard may define one of an identity preservation program, a specialty trait tracking program and a food safety certification program.

The commodity data may include source data identifying the source of the commodity.

In accordance with a feature of the present aspect, the commodity analysis systems are configured to analyze one or more commodities to provide measurement data for each commodity analyzed; examine said measurement data to determine at least one commodity characteristic; and generate the commodity data for particular discrete quantities of the one or more commodities. The commodity analysis systems may be configured to examine the measurement data in accordance with a library of comparative data for determining commodity characteristics. And further, the commodity analysis systems may be configured to use one or more artificial intelligence programs for determining commodity characteristics.

Preferably, at least one commodity analysis system is configured to periodically gather commodity data from a plurality of commodity analyses into a batch and transmit the batch to the information retrieval system for storing said commodity analysis data. As well, the information retrieval system may include a billing component for billing a use of the commodity analysis systems. As a further option, the information retrieval system may comprise an update component to transmit an update to at least one of the commodity analysis systems, the update comprising one of a software update, a lease update and a data update.

Another feature of the system provides that at least one commodity analysis system comprises a regulation component to regulate the generation of commodity analysis data in response to a current permission defined by the information retrieval system.

Further aspects of the invention provide for one or more computer program products having a computer readable medium tangibly embodying computer executable code to manage the commodity data for a chain of production in which one or more commodities are used in one or more production steps.

### BRIEF DESCRIPTION OF THE DRAWINGS

Further features and advantages of the present invention will become apparent from the following detailed description, taken in combination with the appended drawings, in which:

FIG. 1 is a schematic diagram of an embodiment of the system in accordance with the invention in a chain of production showing a flow of a commodity through the chain and flow of data;

FIG. 2 is a block diagram of a preferred embodiment of the system in accordance with the invention; and

FIG. 3. is a flowchart of a preferred embodiment of the method in accordance with the invention.

It will be noted that throughout the appended drawings, like features are identified by like reference numerals.

### DETAILED DESCRIPTION OF THE PREFERRED EMBODIMENT

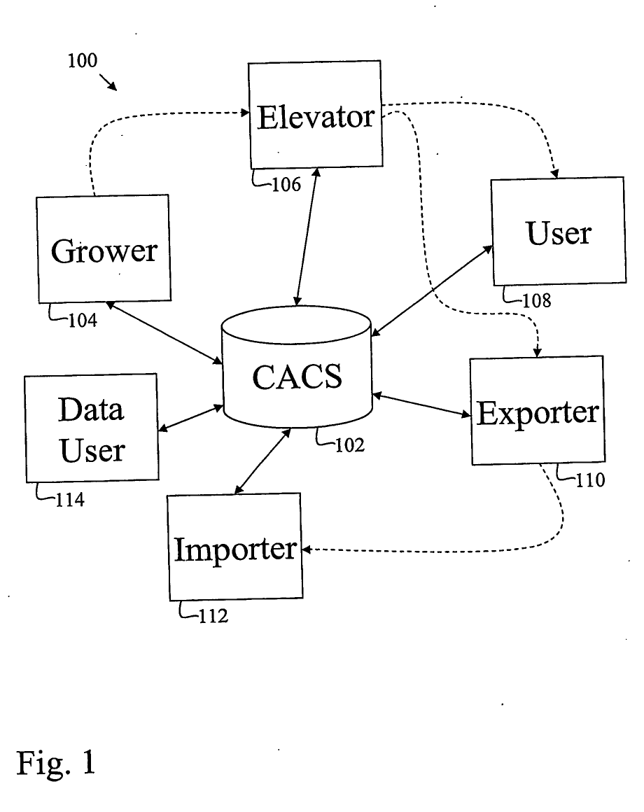

FIG. 1 is a schematic diagram of an embodiment of a chain of production system (CPS) 100 in accordance with an embodiment of the invention for managing commodity data. FIG. 1 illustrates a flow of a commodity (for example grain) between members (104-112) of the chain of production and a flow of data between each member and a central information retrieval system defining a commodity analysis collection system (CACS) 102.

Generally, a commodity such as grain originates with a grower or other producer 104. Growers can generate commodity data, for example by measuring the commodity using a commodity analysis system (CAS) (not shown) before transferring the commodity along the chain to an elevator 106. The commodity data is sent to CACS 102 including a database for receiving such data. Grain elevators or other terminals in the chain may analyze incoming and outgoing shipments of the commodity to generate further commodity data. Again, analysis may be performed using a CAS (not shown) and transmitted to CACS 102. Similarly other members in the chain such as users 108, exporters 110 and importers 112 may perform commodity analysis to generate and transfer commodity data as the commodity flows through the chain.

In addition to generating commodity data, members in the chain may retrieve commodity data or information from CACS 102. The data may facilitate the determination of a use of the commodity, for example, to determine a blending of a quantity of the commodity with another quantity of the same or a different commodity. As quantities or blended or used, commodity data may be associated with the resulting commodity to facilitate tracing throughout the chain of production. Uses of the commodity as facilitated by the commodity data may be in accordance with a standard established for the commodity. Other data users 114 such as suppliers or service providers to or regulators of the members of the chain may also be given access to the commodity data via CACS 102.

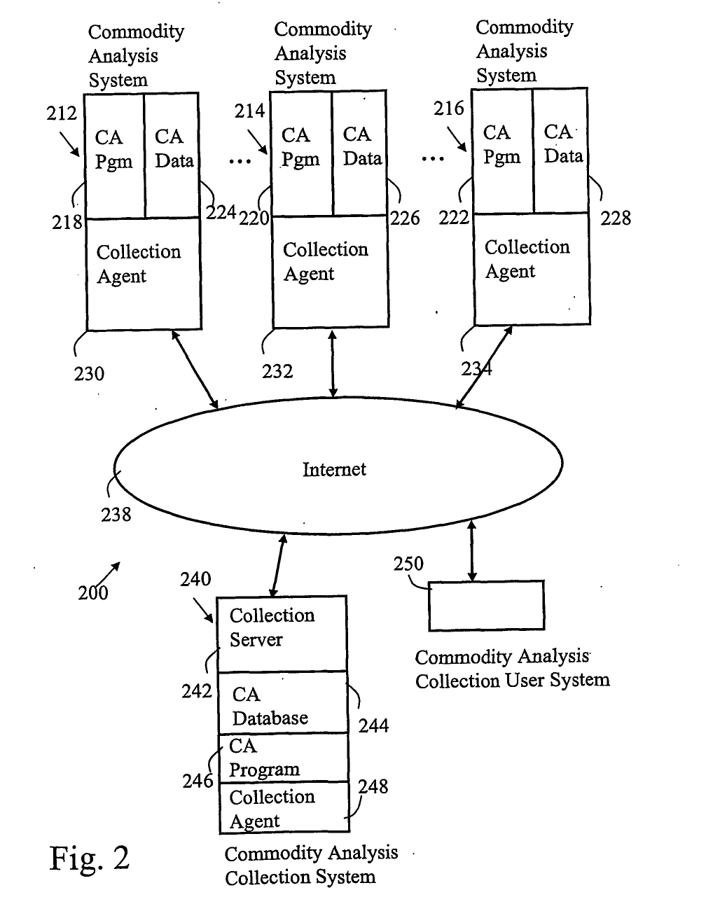

FIG. 2 illustrates a block diagram of a system 200 for managing commodity analysis data and information in accordance with a preferred embodiment of the invention. System 200 comprises at least one commodity analysis system (CAS) such as systems 212, 214 and 216 coupled for communication with an information retrieval system (i.e. commodity analysis collection system (CACS)) 240. In the preferred embodiment, CAS 212, 214 and 216 and the CACS 240 are coupled for network communication via the Internet 238. However, it is understood that other public or private networks or combinations thereof may be employed, whether wired or wireless, sufficient to communicate signals between CACS 240 and each CAS 212, 214 and 216. Therefore, CAS 212, 214 and 216 may be positioned in remote locations from CACS 240, such as, in the case of grain analysis systems, at a farm, grain elevator, transportation port, mill, or other point in a chain of production (see FIG. 1).

Each CAS 212, 214 and 216 typically comprises a computer (e.g. a personal computer (PC)) including a programmable processor (not shown) coupled with one or more instruments, for example, an imaging sensor (not shown), for detecting at least one characteristics of at least one commodity. Preferably, each computer includes a display device such as a display monitor and one or more input devices, for example a keyboard, pointing device and the like for operating the computer (all not shown). The computer also includes a network interface device (not shown) for facilitating Internet communications and one or more storage devices (not shown) for storing programs and data such as an operating system and applications as described further below.

Each CAS processor may be programmed by a respective commodity analysis program (CA program) 218, 220 and 222. A CA program instructs steps for analyzing the output of the instrument(s) with which a processor is coupled and for determining one or more characteristics of the commodity giving CA data 224, 226 and 228. Further, the CA program may instruct steps for displaying the CA data to a user of the CAS and for locally storing the CA data as described further below.

A primary function of each CAS is the analysis of a commodity to determine one or more commodity characteristics of interest to members of the chain. It is understood that such characteristics may vary in accordance with the commodity as well as the member. Thus, each CAS is preferably configurable to determine a plurality of characteristics for any one commodity and preferably is configurable to analyze more than one commodity. The commodity characteristics determined by an instrument controlled by a CA program may include inherent characteristics such as color, weight, moisture content, shape, etc. and other commodity properties as well as secondary characteristics determined from such inherent measurable characteristics. Secondary characteristics may include variety, disease presence, quality or other valuations in accordance with one or more defined standards for a commodity. For example, a CAS may be configured for detection of grain varieties with specific traits such as genetically modified organism (GMO) varieties or other disease tolerances such as Fusarium tolerance described below.

While each CA program 218, 220 and 222 is illustrated schematically as a single item, it may comprise a plurality of parts such as software and data therefor. For example, the CA program may comprise software for operating the instrument to obtain instrument readings, for manipulating the instrument readings to obtain data for evaluation and for evaluating the data. The CA program may include image or other recognition software such as artificial intelligence program, for example, a neural network and one or more libraries of training data for the neural network defining commodity characteristics and/or standards against which the characteristics may be compared.

Additionally, each CA program 218, 220 and 222 defines a user interface (not shown) such as a graphical interface for operating the respective CAS 212, 214 and 216 as described further below. As well as determining CA data indicative of one or more characteristics of the commodity, the CA program 218, 220 and 222 is configured for receiving additional CA data 224, 226 and 228 through the user interface. Such additional data may comprise one or more identifiers for identifying the particular quantity of the commodity analyzed such as by lot identifier, storage location or a shipping identifier. The CA data may include other identifiers for the specific analysis such as the CAS location, one or more tests performed, date, grower and operator, etc.

Grower or other source data for a commodity received via the user interface may be extensive. Source data for crops may comprise identifiers for determining a grower's particular field, seed variety, soil conditions, fertilizer and other treatments used, and other inputs known to those skilled in the art. To avoid duplicitous entry, at least some of the grower data may be stored, as described further below, to permit correlation with subsequent commodity analysis and other data. For example, a CAS may be configured to set up entries for particular farms, fields or growers which may be correlated. For example, a field may be correlated with one grower one year and another grower another year to reflect new ownership or field use arrangements.

Source data may be useful in order to facilitate certain identity preservation, specialty trait tracking or certification programs through all or part of the supply chain, for managing or planning for particular farms, for studying yield or other measures for a particular seed variety or fertilizer, etc. A CAS or other computer such as a computer 250 described below may be configured, as is understood to persons skilled in the art, with one or more tools or modules to assist with such data uses.

As it is intended in the preferred embodiment that a plurality of CAS will be distributed through out various points or stages in a supply chain, the CA data of interest to be collected at the various points may differ. A CAS that is used for analyzing a commodity as it is received from a grower or other source at an initial stage of a supply chain may be configured to receive different CA data than a CAS that is used to analyze the commodity at a subsequent stage in the supply chain. As is understood by persons skilled in the art, a CA program may be configured for use at one or more stages and may be user selective. Alternately, a CA program may be configured for dedicated use.

For communicating CA data 224, 226 and 228 to CACS 240 as described further below, each CAS 212, 214 and 216 further comprises a respective collection agent 230, 232 and 234.

CACS 240 comprises at least one computer, preferably configured to be suitable as a server and including one or more programmable processors, storage devices and network interface device(s) (all not shown) for storing programs and data therefore to receive CA data from each CAS 212, 214 and 216. As such, CACS 240 comprises a corresponding collection server 242 configured as an information retrieval system cooperating with the collection agents 230, 232 and 234 and a CA database 244. CACS 240 may be configured as a form of information retrieval system for managing computerized records contained in a database known as a relational database management system. Between an actual database such as CA database 244 (that is, data stored for use by a computer) and users of the contents of that database is a software layer known as the relational database management system (RDBMS or DBMS). The DBMS is responsible for handling all requests for access to the database and shielding the users from the details of any specific hardware and/or software implementation. Using relational techniques, the DBMS stores, manipulates and retrieves data in table form. Typically, these relationships are defined by a set of columns, which are also referred to as attributes, of data types and a set of rows, which are also referred to as records or tuples, of data.

In addition to facilitating the collection of CA data in CA database 244, CACS 240, as an information retrieval system, provides a manner to access the collected data in CA database 244 through database queries. Queries may generate reports including information determined from the CA data or may retrieve specific instances of CA data. CACS 240 may further provide an interface to add further context data for correlation with specific CA data. General context data may include weather data or data indicating the known presence of certain commodity diseases in a general geographical area related to the CA data.

More specific context data may include further particulars for the commodity source (e.g. a grower history of disease incidence, farm or other inspection reports, summary of growing practices, etc.), shipping or other transportation or handling data from the particular lot of the commodity, etc.

User access to database 244 may be available through collection server 242 or another server (not shown). Preferably, CACS 240 provides a web-based user interface access method for receiving and answering queries to CA database 244. In the preferred embodiment, the web-based service is a subscription-type service available to registered users for a fee. Access to the CA database 244 through the service may be made via a CAS 212, 214 and 216. Access may also be made via other computers such as by a commodity analysis collection subscriber having a user computer 250 coupled to the Internet. Such users may include, in the context of grain analysis for example, CGC, CLB, grain elevator companies, transportation providers, as well as grain users and purchasers among others in a supply chain for grain. Exemplary uses of CA data in database 244 are described further herein below.

Optionally, CACS 242 also includes the current versions of CA program 246 and collection agent 248 for distribution to a CAS to ensure the CAS is up to date as described further below.

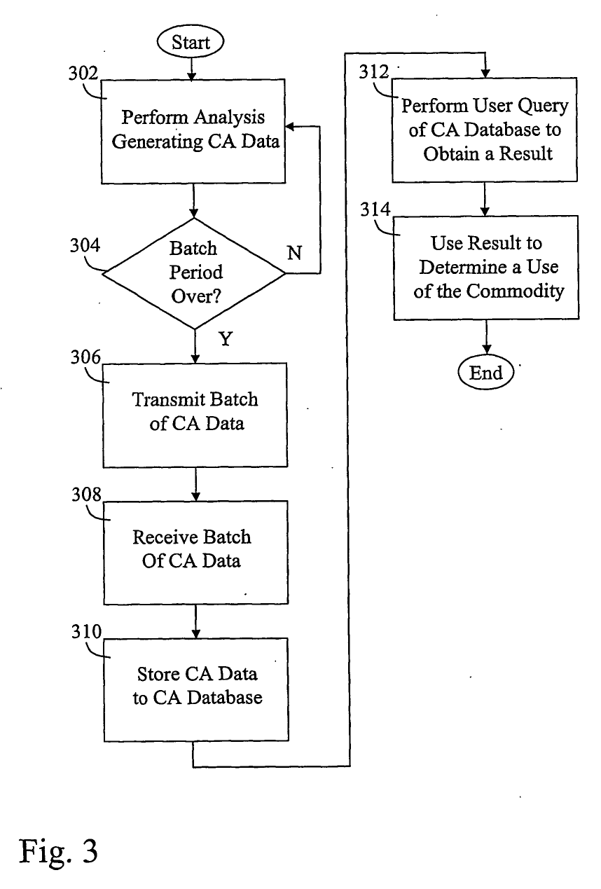

FIG. 3 illustrates a flowchart of operations 300 in accordance with a method of managing commodity information of the invention. At step 302, a CAS operator performs a commodity analysis to determine one or more characteristics of a commodity. Preferably, the operator gains access to the CAS through a password-protected user interface. To analyze a grain sample, for example, the grain sample may be deposited into a feeding mechanism for the sensor. Using a touch screen or other pointing-like interface, the operator selects the tests to be performed by the CA Program of the CAS. The analysis is performed, generating CA data stored locally on the CAS representative of the determined characteristics of the commodity and data to identify the analysis.

Analysis may involve the exemplary steps of:
Capturing a digital image of the grain sample that has a particular resolution;
Digitizing the image to create individual datasets for each seed in the image;
Providing the datasets for interpretation by an image recognition operation (for example, a neural network);
Determining one or more characteristics of the seed (e.g. by the neural network) in accordance with the selected tests;
Presenting the analysis results on a display and making the results available for printing; and
Storing the results.
Additional data may be entered by the operator for identifying the sample analysis as discussed previously.

Preferably, only relevant information will be retained from each analysis—for example, the digital images need not be stored for future use.

Additional analyses may be selected and conducted throughout the day and the CA data therefor stored locally on a storage device coupled to the CAS computer.

Periodically and preferably at regularly scheduled times, selected CA data for the period (e.g. each day or week) are electronically transmitted via the Internet to CACS 240 for storing in central CA database 244 (steps 304 and 306). Preferably, prior to transmission, the CA data for each test are gathered in a batch. The batch may be compressed in accordance with a data compression protocol and/or encrypted in accordance with an encryption protocol all as understood to persons skilled in the art. Preferably, only relevant information selected from the CA data is transmitted for storage. The relevance of the data may be determined by persons skilled in the art with a view to the anticipated uses of the information by a variety of users. Preferably, the CA database 244 and any transmission protocol that may be employed for transmitting the batch data is flexible to account for different data required by different commodity tests.

Collecting CA data in batches facilitates off-line analysis and temporary collection at the CAS. Thus a CAS may be portable for transporting to particular test locations such as a farm. Following one or more commodity analysis tests, the operator may connect the CAS to the Internet to transmit a batch. It is understood that operations may be configured for performance while connected to the Internet as well.

At step 308, the transmitted batch is received by CACS 240. Preferably one or more integrity checks are performed to validate the received CA data, authenticating that the transmission is from an approved CAS and/or operator, etc. At step 310 the CA data is stored to CA database 244. Acknowledgement of the receiving and storing of the data may be transmitted to the CAS (not shown).

This stored CA data is thus available to subscribing users of the service, for example, by way of value-added reports. Step 312 illustrates an exemplary user query of database 244.

Subscribers, such as various members in the chain or other parties can submit user queries to access CA data and correlated data and generate reports. In response to the user query, reports can be viewed online, downloaded and printed. Different subscribers to the service may have different access to information in CA database 244 in accordance with security and other parameters configured for the subscriber. For example, grain company head offices may have a wide degree of access to reports while elevator managers may have a lower level of access to reports from their own elevators. In accordance with conventional methods, access to the subscriber service should be secure to prevent unauthorized access to the database, the reports and subscriber information especially during transmission over the network.

The subscriber service may offer pre-defined reports or customizable reports as is well understood to persons skilled in the art. While it is contemplated that reports are generated in response to a subscriber request via a web-based interface, persons skilled in the art will recognize that other reporting mechanisms may be within the scope of the invention. For example, a subscriber may select to have a particular report generated periodically (e.g. monthly) and electronically transmitted to the subscriber such as via email.

The commodity analysis data managed and information therefrom may be used in a variety of ways by members of the supply chain. Upon initial receipt of a quantity of a commodity. CA data therefor may be used to determine a storage location for the commodity, for example, to segregate commodities with desired traits or in accordance with grade or other measures. Some members may use CACS 240 when determining a particular use for a commodity in the supply chain (step 314). For example, database 244 may be queried when combining (e.g. blending) quantities of a commodity in accordance with a standard for the commodity. Database queries may be performed to determine particular quantities of a commodity that exhibit (or do not exhibit) certain traits to facilitate blending. A user may desire a commodity that is free of a certain disease or comprises disease resistant varieties. Conversely, a user may wish to avoid certain varieties. Though not shown in FIG. 3, a blended commodity may be analyzed and CA data therefore stored in CA database 244. This CA data may be correlated to CA data from the particular commodities used to make the blend. Similarly other commodities used and produced in the supply chain may be linked to facilitate ready tracking.

CA database 244 presents numerous other advantages. One such advantage is the facilitation of traceability. Traceability refers to the ability to track a commodity and thereafter recall its CA data as the commodity flows through a supply chain. In the grain industry, for example, grain from multiple sources may be blended and distributed widely for different uses. CA database 244 provides a manner in which to track CA data throughout the supply chain from farmer to grain elevator, transportation provider, intermediaries and end user(s). Traceability of source identity and commodity characteristics such as quality or disease is particularly important. At any point in the distribution chain, appropriate queries to CA database 244 may be made to provide one or more reports concerning the commodity. For example, a user may wish to evaluate a particular grain shipment for its reported history of disease detected by a CAS at some point in the supply chain, to identify a source (or sources) of the commodity or the geographical location (or locations) of the source of the commodity. The geographical location may be an indicator of the likelihood of the presence of a particular disease. Again, the query result may determine a use for the particular commodity.

Having more commodity analysis data readily available for commodities such as grain provides many enhancement opportunities to those working with the commodity. The data is useful for reducing health risks from diseased grain to those consuming the grain, including animals. Grains such as wheat and barley, oats and other small cereal grains and corn may suffer a fungal disease known as Fusarium Head Blight (FHB) caused by several species of Fusarium. This disease reduces crop yield and grade, but more importantly, may also contaminate the grain with fungal toxins (mycotoxins). Diseased crop spikelets can contain visibly affected kernels, termed fusarium damaged kernels (FDK) in the grading of wheat or fusarium mould for barley. Wheat and barley infected with FHB may contain toxins such as deoxynivalenol (DON) also known as vomitoxin. Vomitoxin, if consumed by animals, may result in reduced feed consumption or feed refusal increasing the cost of production. Rates and geographical locations of fungal infections of crops are tracked by various agencies in order to assess the risks presented to various industries, the environment and people.

More and better commodity data permits blending of grain closer to required specifications and the better matching of grain to a required end use. Certain grains exhibit better baking characteristics and may be directed to use as flour, for example. Better and more consistent grain analysis lowers the risk of downgrades at ports or other points along the distribution chain. A central data warehousing approach that collects data from geographically disperse points in a supply chain facilitates convenient value-added use and re-distribution. As such, all members in the supply chain for the commodity may be part of a common system.

In the preferred embodiment, the CACS 240 further provides a mechanism (not shown) to update via a software update a CA Program at a CAS, in whole or in part. The updates may reflect changes to previous functionality or to add new functions including particular commodity tests. In an exemplary method of updating, on a regular basis, the version of any CA Program (e.g. recognition program, such as a neural network and training data, or user interface) installed on the CAS may be compared with the latest versions of same indicated by CA Program 246 of FIG. 2 stored at CACS 240. If the version at a CAS is out of date, a notification may be made to the operator of the CAS and a new version may be automatically downloaded and installed to the CAS in accordance with conventional methods understood to persons skilled in the art. Preferably, to ensure that each CAS is always using the most current software, the operators thereof are not given an opportunity to decline a software update.

Optionally, a billing mechanism may be integrated into CACS 240 for tracking the use of each CAS for generating invoices. For example, CACS 240 may be configured to invoice routinely and automatically a member of the chain, such as a CAS operator, in accordance with the number and type of commodity analyses preformed and tracked during a particular time period. The billing mechanism may be configured for electronic or non-electronic notification and payment methods in accordance with conventional techniques. Preferably, invoice and reporting formats are flexible to meet customer needs. A billing mechanism for the retrieval of CA data and information from CACS 240 may also be incorporated. A subscription or other service model may be used. Charges may be based upon the types of retrievals and reports generated, upon a periodic flat rate (e.g. monthly subscription fee) etc. which may vary by the numbers or types of users. Enterprise rates, individual user rates, supply chain member rates, third party rates, among others may be contemplated.

Optionally, in order to ensure that a CAS is not used in a manner that prevents correct invoicing, operation of a CA Program may be regulated. Should a CAS continue to be operated but fail to provide regular updates of CA data to CACS 240 to trigger a billing event or check for software updates, that CAS may be regulated to prevent further use of the CA Program. For example, each time a CAS transmits a batch of CA data to CACS, CACS may transmit and CAS may receive a lease update or other current permission defined by the CACS permitting CAS to operate for a predetermined time period or number of tests. If the CAS does not reconnect to CACS and transmit a batch of CA data, a regulation mechanism may prevent CAS from performing further tests unless and until the CAS provides the CA data as required. Of course, if no data was generated during the period, a transmission advising that no data is available may also be sent to the CACS.

One or more warnings may be generated by CA Program as the end of the lease approaches or should an error occur such as the unsuccessful automatic transmission of CA data or the unsuccessful receipt of a lease or software update. CA program or a CAS operator may then initiate a further transmission to obtain the lease. If necessary, an override may be permitted to allow further testing despite a lease expiry or to use a previous version of the software.

In addition to transmitting data to a CACS, a CAS may be optionally configured for transmitting CA data for storage to another database such as a database for a chain of production member's corporate Enterprise Resource Planning (ERP) system. Similarly, CAS may be configured to optionally receive a data update of information particular to a member's CAS such as a customer list so that a CAS operator may select from a pre-populated list of customers and avoid entering duplicate or erroneous data.

Many advantages to the method and system of the present invention are apparent. For example, the invention provides a manner to conveniently generate commodity analysis data reports from dispersed analysis systems to track a commodity as it flows through a supply chain. Users may determine better uses for a commodity, directing the commodity to appropriate uses that may increase value. For example, more precise blending through more frequent sampling and more accurate analysis of those samples is enabled, resulting in reduced risk for the elevator and assuring more accurate payment to the farmers for their grain.

In addition to comprising one or more instruments for analyzing a commodity per se, a CAS computer may be coupled to one or more instruments (not shown) for measuring or acquiring other related data. For example, a global positioning sensor may be employed to provide location data particularly for portable test systems. Devices for measuring characteristics of soil, water or growing environment variables may also be used for relating to particular commodities. Data from these measurements may be incorporated as CA data for providing to the CACS.

A CAS, particularly one employing neural network or other artificial intelligence for recognition of characteristics may be configured and trained for agricultural commodities other than grain. For example, a CAS may evaluate flour based on color and texture characteristics, or be trained to evaluate the quality of meats and detect a presence of a steroid from the meat fiber texture. The CAS could also be used to help in the blending of grass mixtures for different turf uses. Additionally, a CAS may be trained to assess the size of feed particles after milling, the presence of mycelium of different plant diseases on leaves, the count of bacteria in water samples or the sugar content in potatoes. The present invention may be adopted for commodities other than those generated by an agricultural chain of production as well. Such other commodities include commodities for other industries such as the aquacultural, biological or pharmaceutical industries and industrial manufacturing. For example, the CAS could be trained to evaluate the color consistency of white paper and, potentially, paper porosity, eliminating the hazardous use of mercury and significantly reducing cost. The CAS could be used to count or inspect small particles currently done by more expensive machine vision equipment. CA data for such tests may be stored to a CACS and tracked through a chain of production. Aggregate data may be compiled and retrieved via the CACS.

Though neural networks are described for recognition of characteristics, other artificial intelligence techniques, such as fuzzy logic-based recognition, or combinations of techniques may be used without departing from the scope of the teachings herein.

The embodiment(s) of the invention described above is (are) intended to be exemplary only. The scope of the invention is therefore intended to be limited solely by the scope of the appended claims.

1. For an information retrieval system coupled to at least one commodity analysis system configured to analyze at least one commodity to generate commodity data comprising at least one commodity characteristic, a method of managing the commodity data for a chain of production in which one or more commodities are used in one or more production steps, the method comprising:
updating the at least one commodity analysis system to maintain the currency of the commodity analysis system;
receiving the commodity data from the at least one commodity analysis system for discrete quantities of at least one commodity used or produced by the chain of production;
storing the commodity data to the information retrieval system; and
determining commodity information in accordance with the contents of the information retrieval system.

2. The method as claimed in claim 1 wherein the at least one commodity comprises one of an agricultural commodity, an aqua cultural commodity, an industrial commodity, a biological commodity and a pharmaceutical commodity.

3. The method as claimed in claim 1 wherein the production steps comprise one or more of acquiring, blending, refining, and transporting the discrete quantities and wherein the commodity data is generated in response to a production step.

4. The method as claimed in claim 1 including providing the commodity information to determine a use of at least a portion of at least one of the discrete quantities in the chain of production.

5. The method as claimed in claim 4 wherein the use is defined in accordance with a standard responsive to one or more commodity characteristics.

6. The method as claimed in claim 5 wherein the standard defines one of an identity preservation program, a specialty trait tracking program and a food safety certification program.

7. The method as claimed in claim 1 wherein said determining commodity information includes tracing commodity data for particular discrete quantities as said quantities flow through said chain of production.

8. The method as claimed in claim 7 wherein instances of said commodity data are generated for a particular discrete quantity as the quantity flows through the chain of production and wherein said tracing comprises associating said instances of the commodity data with one another in the information retrieval system.

9. The method as claimed in claim 1 wherein the at least one commodity characteristic includes at least one of a measured characteristic of the particular discrete quantity and a secondary characteristic determined for the particular discrete quantity.

10. The method as claimed in claim 1 wherein the commodity data includes one or more source data identifying characteristics of the source of the commodity.

11. (canceled)

12. The method of claim 1 wherein updating comprises transmitting to the at least one commodity analysis system at least one of a software update, a lease update, and a data update.

13. The method as claimed in claim 1 including providing a user interface for obtaining commodity information determined from commodity data stored to the information retrieval system.

14-29. (canceled)

30. For an information retrieval system coupled to a commodity analysis system configured to analyze at least one commodity to generate commodity data for a chain of production in which one or more commodities are used in one or more process steps, a method of managing the commodity analysis system comprising:
receiving commodity data at the information retrieval system from the commodity analysis system for discrete quantities of at least one commodity used or produced by the chain of production; and
tracking a use of the commodity analysis system.

31. The method as claimed in claim 30 including invoicing in response to the determined use of the commodity analysis system.

32. The method as claimed in claim 30 including transmitting an update to the commodity analysis system.

33. The method of claim 32 wherein the update comprises at least one of a software update, a lease update, and a data update.

34. The method as claimed in claim 30 including configuring the commodity analysis system to at least one of: automatically transmit commodity data to the information retrieval system, receive an update from the information retrieval system, and fail to generate commodity data in the absence of a current permission defined by said information retrieval system.

35. A computer system for managing commodity data for a chain of production in which one or more commodities are used in one or more production steps, the system comprising:
an information retrieval system for storing commodity data for a plurality of discrete quantities of at least one commodity used or produced by the chain of production, the commodity data for each particular discrete quantity comprising at least one commodity characteristic; and
a plurality of commodity analysis systems coupled to the data storage system for generating commodity data to be stored by the data storage system, each commodity analysis system operating under control of a program to perform commodity analysis and storage operations as identified by said program; and each commodity analysis system including at least one instrument for analyzing the commodity for determining the at least one commodity characteristic; and
said information retrieval system adapted to update the commodity analysis systems to maintain currency.

36. The system as claimed in claim 35 wherein each said commodity analysis system comprises a user interface for receiving commodity data for storing to said information retrieval system in association with commodity data determined by analysis.

37. The system as claimed in claim 35 wherein said commodity analysis system is adapted via a user interface for retrieving commodity information from said information retrieval system.

38. The system as claimed in claim 37 wherein the commodity information is retrieved for determining a use in the chain of production of at least a portion of at least one of the discrete quantities.

39. The system as claimed in claim 37 wherein said information retrieval system is configured to enable tracing of commodity data as particular quantities of a commodity flow through said chain of production.

40. The system as claimed in claim 35 wherein the commodity analysis system is configured for determining at least one commodity characteristic for evaluating compliance with a commodity standard.

41. The system as claimed in claim 40 wherein the commodity standard defines one of an identity preservation program, a specialty trait tracking program and a food safety certification program.

42. The system as claimed in claim 35 wherein the commodity data includes source data identifying the source of the commodity.

43. The system as claimed in claim 35 wherein the commodity analysis systems are configured to:
analyze one or more commodities to provide measurement data for each commodity analyzed;
examine said measurement data to determine at least one commodity characteristic; and
generate the commodity data for particular discrete quantities of the one or more commodities.

44. The system as claimed in claim 43 wherein the commodity analysis systems are configured to examine said measurement data in accordance with a library of comparative data for determining commodity characteristics.

45. The system as claimed in claim 44 wherein the commodity analysis systems are configured to use one or more artificial intelligence programs for determining commodity characteristics.

46. The system as claimed in claim 35 wherein at least one commodity analysis system is configured to periodically gather commodity data from a plurality of commodity analyses into a batch and transmit the batch to said information retrieval system for storing said commodity analysis data.

47. The system as claimed in claim 35 wherein the information retrieval system includes a billing component for billing a use of the commodity analysis systems.

48. The system as claimed in claim 35 wherein the information retrieval system comprises an update component to transmit an update to at least one of the commodity analysis systems, the update comprising one of a software update, a lease update and a data update.

49. The system as claimed in claim 35 wherein at least one commodity analysis system comprises a regulation component to regulate the generation of commodity analysis data in response to a current permission defined by the information retrieval system.

50.-83. (canceled)
